(19) United States
(12) Patent Application Publication
(10) Pub. No.: US 2020/0350948 A1
(43) Pub. Date: Nov. 5, 2020

(54) AN ADAPTIVE SELF-INTERFERENCE CANCELLING SYSTEM FOR 5G FULL DUPLEX AND MASSIVE MIMO SYSTEMS

(71) Applicant: SABANCI UNIVERSITESI, Istanbul (TR)

(72) Inventors: Yasar GURBUZ, Istanbul (TR); Ilker KALYONCU, Istanbul (TR)

(73) Assignee: SABANCI UNIVERSITESI, Istanbul (TR)

(21) Appl. No.: 16/760,471

(22) PCT Filed: Nov. 14, 2018
(86) PCT No.: PCT/TR2018/050684

§ 371 Date: Apr. 30, 2020

(30) Foreign Application Priority Data
Nov. 16, 2017 (TR) 2017/18093

(51) Int. Cl. H04B 1/525; H04L 5/14; H04B 1/04

(52) U.S. Cl. CPC H04B 1/525; H04B 2001/0408; H04B 1/04; H04L 5/14

(57) ABSTRACT

A full-duplex self-interference cancelling system operable in 28 GHz data rate levels, therefore well compatible with 5G systems such as massive MIMO transmitter-receiver radios and mm-waves, designed to include an antenna to improve signal-to-noise ratios (SNR) and elimination of self-interference-based noise and an adaptive, blind performing self-interference canceller module. In other words, the present invention comprises a self-interference canceller using variable-gin amplifiers to adjust a receiving signal post-dissection into in-phase and quadrant constituents thereof via an I/Q modulator, entire process of which is overseen and dictated by a digital control block.

### CROSS REFERENCES TO THE RELATED APPLICATIONS

This application is the national phase of International Application No. PCT/TR2018/050684, filed on Nov. 14, 2018, which is based upon and claims priority to Turkish Patent Application No. 2017/18093, filed on Nov. 16, 2017, the entire contents of which are incorporated herein by reference.

### TECHNICAL FIELD

Disclosed invention generally concerns massive MIMO (Multi Input Multi Output) and phased-array transmitter-receiver radios compatible with new generation 28 GHz data transfer 5G systems antenna design usable therefor with an adaptive and blind operating self-interference cancellation systems of improvement signal-to-noise ratio (SNR) and reduction of noise resulting from self-interference.

### BACKGROUND

Self-interference cancelling/suppressing antenna designs, in addition to passive design filters utilizing modules and various combinations thereof performing within predefined frequency ranges are known in the art. Next to physical isolation via a certain distance between transmitting and receiving radio antennas, non-physical interference cancellation and suppression is also possible via filtering, superposition and I/Q separation based on the signal difference in said transmitting and receiving antennas within the framework of which signal processing methods are also utilized.

New generation data transmission technologies have amassed a considerable growth in amount of data transferrable per unit time between two ends or as broadcast, as well as a growth in speed of data transmission. Massive Multi Input Multi Output (MIMO) antenna designs may comprise serially operated antennas with embodiments containing 128 instances thereof, besides systems utilizing said antenna arrays reaching data transmission routes over frequencies of up to 25 GHz and beyond. Such systems including full-duplex antennas, i.e. ones that display simultaneous transmission and reception capabilities are expected to become widespread for various ends, including 5G data transfer applications paired with methods such as mm-wavelengths and beamforming. Next to this, these mechanisms also bear considerable technical issues and shortcomings. To begin with, while full-duplex systems potentially double the spectral efficiency, they also pose a problem of self-interference emanating from their intrinsic structural properties. Since this would hamper data safety in systems where massive amounts of data are transferred in a fast manner, it is imperative to introduce such interference suppression and cancellation measures to improve signal-to-noise ratios.

Study titled “A 28-GHz 32-Element TRX Phased-Array IC With Concurrent Dual-Polarized Operation and Orthogonal Phase and Gain Control for 50 Communications” by Sadhu et al. published in IEEE Journal of Solid-State Circuits (Volume: 52, Issue: 12, December 2017) reports a 28-GHz phased-array IC for 5G communications that is implemented in 130-nm SiGe BiCMOS and includes 32 TRX elements, further featuring concurrent independent beams in two polarizations in either Tx or Rx operation. Circuit techniques to enable precise beam steering, orthogonal phase and amplitude control at each front end, and independent tapering and beam steering at the array level are presented. TX path loss is minimized through a TX/RX switch design resulting in 13.5 dBm/16 dBm OpIdB/Psat per front end with >20% peak power added efficiency of the power amplifier (including switch and off-mode LNA) while maintaining a 6-dB noise figure in the low noise amplifier (including switch and off-mode PA).

Another study by Dunworth et al. titled “A 28 GHz Bulk-CMOS dual-polarization phased-array transceiver with 24 channels for 5G user and basestation equipment” published in 2018 IEEE International Solid-State Circuits Conference discusses next-generation cellular technology (5G) in the mm-wave bands and requirements thereof such as low-cost phased-array transceivers, space constraints in the mobile form-factor, increasing TX output power while maintaining acceptable PA PAP, LNA NTT, overall transceiver power consumption and phased-array transceiver ability yo support dual-polarization communication. An IF interface to the analog baseband is desired for low power consumption in the handset or user equipment (LTE) active antenna and to enable use of arrays of transceivers for customer premises equipment (CPE) or basestation (BS) antenna arrays with a low-loss IF power-combining/splitting network implemented on an antenna backplane carrying multiple tiled antenna modules.

One study by Sowlati et al. titled “A 60 GHz 144-element phased-array transceiver with 51 dBm maximum EIRP and ±60° beam steering for backhaul application,” proposes a full-featured 802.11ad chipset with 144-element phased array using a tiled approach and CMOS IPs developed for WiGig to address low-cost municipal WiFi, backhauling, and broadband to home covering the last mile. Designed with a link budget of 120 dB+, the phased-array solution can be mounted on top of lamp posts and roof-top buildings covering a 200 m LOS, and with tens of hops a range of 2 km can be covered from a single point of fiber. Moreover, the steerable phased arrays enable dynamic routing optimization between hopping nodes in a mesh network.

Gu et al. in their study titled “A multilayer organic package with 64 dual-polarized antennas for 28 GHz 5G communication” as published in 2017 IEEE MTT-S International Microwave Symposium (IMS) propose a phased array transceiver module developed with the package and four SiGe BiCMOS ICs are attached using flip-chip assembly. Module-level measurements in Tx mode show 54 dBm EIRP and near-ideal 35 dB gain increase for 64-element power combining. 64-element radiation pattern measurements with a steering range of >±40 degrees without tapering in off-boresight direction. Pang et al. in their study titled “A 28 GHz CMOS Phased-Array Transceiver Featuring Gain Invariance Based on LO Phase Shifting Architecture with 0.1-Degree Beam-Steering Resolution for 5G New Radio” published in 2018 IEEE Radio Frequency Integrated Circuits Symposium (RFIC) disclose a CMOS implementation of 28-GHz 4-element phased-array transceiver for 5G new radio. The proposed LO phase shifting architecture realizes very fine 0.04° phase tuning step and gain-invariant feature. An 8-element transceiver demonstrates the measured 0.1-degree beam-steering resolution and less than 0.2 dB gain variation over the whole phase tuning range. In as-meter distance, the transceiver achieves 6.4 Gb/s in 256QAM for beam angle of ±50° together with a maximum data rate of 15 Gb/s in 64QAM and consumes 1.2 W/chip in TX mode and 0.59 W/chip in RX mode.

Improvements on antennas themselves focusing on design are possible: Antenna separation where transmitting and receiving counterparts are physically distanced, antenna cancellation and cross polarization methods, although suppressing self-interference to a degree, are inapplicable in cases when numerous antennas are arranged in formations where they are almost adjacent. One prior art document, US 2016079672 teaches an antenna structure based on a patch antenna comprising stacked layers. Said design is capable of suppression levels up to 20 dB on 5.4 GHz frequency, however since it relies on cross polarization principle, it is unable to be applied to MIMO arrays.

For self-interference cancellation besides ones stemming from intrinsic properties of antenna design; document number U.S. Pat. No. 5,691,978 disclosed a system where an adaptive digital baseband canceller is paired with an analog radio frequency suppressor operable in a wide scale. However, this system performs in a predefined set of bandwidths and frequency values; meaning adaptivity and modularity are lacking.

Yet another document known in the prior art is an application by Qualcomm, US 2016211882, teaches a system capable of multiple styles of self-interference suppression based on an advanced algorithm, with the aid of modules that include additional integrating circuits, passive elements such as filters paired up with control methodologies. Aforementioned system, while its effectiveness and adaptivity are documented in LTE, WLAN and WPAN spectrums, its potential regarding 5G technologies is unclear.

Still another document known in the art, US 20160352386, teaches an apparatus and a method for cancelling self-interference caused by full-duplex communication. While it is receiver-oriented since receiver experiences bulk of the self-interference from the device's own transmitter, the apparatus and method are configured to adjust a phase and gain of the outbound signal provided at the output of a power amplifier (PA) and inject the phase and gain adjusted outbound signal at the input of a low-noise amplifier (LNA) to cancel the interference from the outbound signal in the inbound signal.

WO 2014027231 discloses an apparatus and method enabling a full duplex system with self-interference cancellation. Receiving circuitry forming a signal receiving path is arranged for transferring communication signals received via air interface. Transmitting circuitry forming a signal transmission path is arranged for transferring communication signals to be transmitted via air interface. Interference cancellation circuitry is in operable connection between the signal receiving path and the signal transmission path. The receiving circuitry and the transmitting circuitry are arranged to receive and transmit communication signals at the same time and at the same frequency. Said interference cancellation circuitry comprises resistance, inductance and capacitance arranged to constitute a center frequency of an isolation range between the signal receiving path and the signal transmission path which substantially falls into the center of a communication band for the signals received and/or to be transmitted via air interface.

An object of the present invention is to provide a radio frequency (RF) front-end.

Another object of the present invention is to provide a system-level solution for full-duplex self-interference (SI).

A further object of the present invention is to provide a system for adaptive self-interference (SI) cancellation.

A further object of the present invention is to provide a system for blind cancellation of self-interference (SI).

A further object of the present invention is to provide a system for self-interference (SI) cancellation compatible for 5G applications.

A further object of the present invention is to provide a system for self-interference (SI) cancellation compatible for massive MIMO applications.

A further object of the present invention is to provide a system for self-interference (SI) cancellation marked by stability and good power consumption characteristics.

### SUMMARY

It is disclosed herein that, according to the main and dependent claims and the description proposed is an invention in the context of a system-level radio frequency (RE) front-end capable of self-interference (SI) cancellation as a particular technical problem. Inventive aspects of the system emanate from blindness (user do not need to specify anything about the SI signal), integrated nature (a single chip canceller), adaptivity (canceller can track environmental changes around the antenna) and simplicity (digital control circuitry uses only 1-bit information at each cycle), compatible for full-duplex architectures with 5G applications characterized by increased data rates and further marked by massive MIMI) compatibility on phased arrays therewithal.

Said self-interference cancellation system essentially is a radio frequency front end consisting of two subdivisions, one antenna with advanced passive isolation and one digital feedback-based suppressor circuit. Both of said parts, while standalone effectivity thereof is ensured, operate together in a way indispensable to the present invention. First subdivision, a double-polarised patch antenna array designed to comply with 35 dB passive antenna suppression levels, realisable in two different embodiments comprising 4 to 5 different dielectric layers. The architecture in the disclosed invention teaches four antennas in both transmitting and receiving property to display principal characteristics of antenna arrays. Apart from said antennas, a similar process is handled by an impedance matching network at this level, still awarding passive suppression. Second module, based on the signal difference in transmitting and receiving ends, produces a cancelling signal by splitting a coupled transmitting signal into its in-phase and quadrant constituents and altering said constituents using voltage gain amplification followed by a refactorization over a digital control block. When this cancelling signal is added to the receiving end signal, active suppression is achieved.

### BRIEF DESCRIPTION OF THE DRAWINGS

Accompanying drawings are given solely for the purpose of exemplifying an adaptive self-interference cancelling system, whose advantages over prior art were outlined above and will be explained in brief hereinafter.

The drawings are not meant to delimit the scope of protection as identified in the Claims, nor should they be referred to alone in an effort to interpret the scope identified in said Claims without recourse to the technical disclosure in the description of the present invention.

FIG. 1 demonstrates top view of the self-interference cancellation system in the context of the disclosed invention.

FIG. 2 demonstrates the circuit schematic of the active self-interference canceller circuit in the context of the disclosed invention.

FIG. 3 demonstrates the flow diagram of an exemplary algorithm of a kind employed by the digital control block in the context of the disclosed invention.

FIG. 4 demonstrates the circuit schematic of the active combiner circuit that combines the in-phase and quadrant constituents of the signal post-adjustment via variable gain amplifiers in the context of the disclosed invention.

FIG. 5 demonstrates top view of a Type-I patch antenna and top perspective view of the metallization layers thereof in the context of the disclosed invention.

FIG. 6 demonstrates top view of the first and second trilayers of a Type-II patch antenna and top perspective view of the metallization layers thereof in the context of the disclosed invention.

### REFERENCE LIST

1) SI cancellation system
2) Patch antenna
3) Rx signal path
4) Tx signal path
5) Low noise amplifier
6) Power amplifier
7) Adaptive SI canceller
8) Cancelling signal path
9) Error signal path
10) Adaptive SI canceller input
11ab) Couplers
12) Suppression combiner
13) I/Q modulator
14ab) Variable gain amplifiers
15) Vector combiner
16) Power detector
17) Analog-to-digital converter
18) Digital control block
Type I antenna:
19) Type-I antenna
20) Patch
21) Aperture slot
22) Tx feed
23) Site chip
24) Supply connections
25) Rx feed
26) Type-I first layer
27) Type-I second layer
28) Type-I third layer
29) Type-I fourth layer
30) Type-I fifth layer
Type II antenna:
31) Type-II antenna
32) Patch
33) Coupling strips)
34) Aperture slot
35) Rx feed
36) SiGe chip
37) Supply connections
38) Tx feed
39) First layer
40) Second layer
41) Third layer
42) Fourth layer
43) Fifth layer
44) Sixth layer

### DETAILED DESCRIPTION OF THE EMBODIMENTS

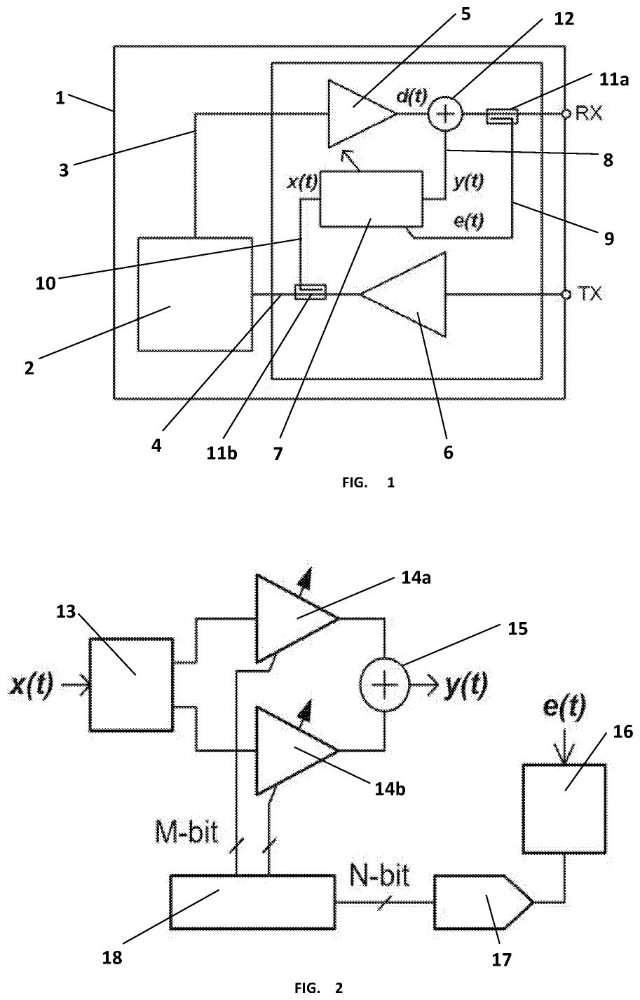

As demonstrated in FIG. 1, the disclosed invention generally concerns a self-interference cancellation system (1). Said self-interference (SI) cancellation system (1) operates with the aim of alleviating/overcoming the problem of self-interference in the context of full duplex systems where radio antennas perform both roles of transmission and reception and 5G system properties such as mm-waves, 28 GHz-level data transmission. SI cancellation system (1), in addition to a 35-dB noise suppression capability arising from the intrinsic design properties of an impedance matching network of a patch antenna. (2) array; followed by the combining of the cancelling signal resulting from a signal processing method controlled with a digital control block (18) with the occurrent signal on the receiving signal path (3), thus achieving its end goal.

Concurrently, said patch antenna (2) unit, having been dual-polarized, has receiving and transmitting ends represented as Rx and Tx respectively. These receiving (3) and transmitting (4) signal paths are further associated with a low-noise amplifier (5) and one power amplifier (6) respectively. adaptive SI canceller (7) which is situated between the output of said low-noise amplifier (5) and the output of said power amplifier (6), happens to be in simultaneous interaction with said receiving (3) and transmitting (4) signal paths with the help of coupling structures.

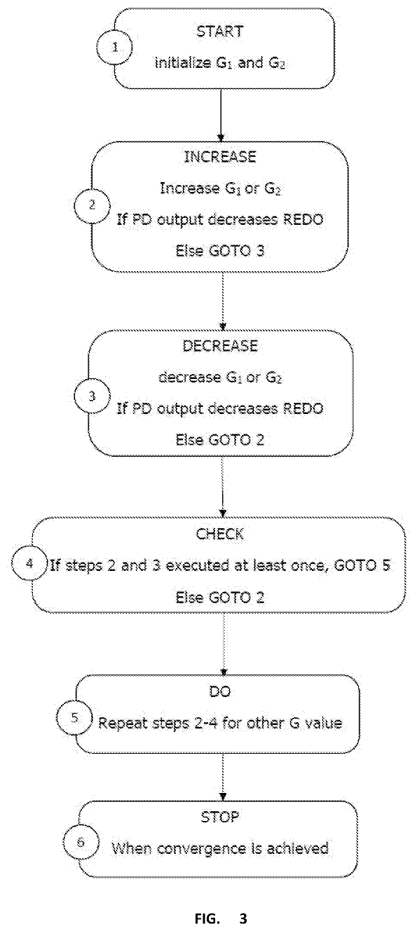

FIG. 2 demonstrates the circuit schematic of adaptive SI canceller (7) visible in FIG. 1 in greater detail. As seen in FIG. 1, the signal to be delivered to the error signal path (9) is coupled directly from the receiving signal path (3), from the output of the low-noise amplifier (5) with the aid of a capacitive coupler (11a) and fed to the power detector (16). This power detector (16) uses a PMOS-type diode connected device as load resistance and has a dynamic range of 52 dB in X-Band. Direct current output received from said power detector (16) is converted to an N-bit digital signal with the aid of an analog-to-digital converter (17). This N-bit digital signal is carried to the input of digital control block (18). Said digital control block (18) controls variable gain amplifiers (14a, b) landed on the outputs of an I/Q modulator (13), feature of which is to effectively converge towards the self-interference signal in the channel, therefore attenuating the error signal energy to smaller levels. This process is in essence an I/Q modulation where in both channels, gain is independently regulated. Said digital control block (18) and variable gain amplifiers (14ab), when compared to other elements in the circuit such as low noise amplifier (5) and power amplifier (6), take up less space and consume quite less energy.

FIG. 3 demonstrates an exemplary algorithm of the kind digital control block (18) handles displayed in FIG. 2. The algorithm which starts execution with initial gain values; increases and/or decreases said gain values in question until convergence is achieved, relying on the premise of comparison with power detector (16) output. Convergence of this algorithm to optimum gain values is ensured by the monotonous increase displayed by variable gain amplifiers (14a, b) in response to the control input. Another property of said algorithm is that it alleviates the concern regarding power detector (16) linearity since comparison is made in relation to only the previous value of said power detector (16) output. Its wide dynamic range as previously denoted, brings with it the ease and flexibility of patch antenna (2) elements in the occurrence of any physical alterations in the vicinity thereof. Both of said variable gain amplifiers (14a, b) are controlled over M-bit digital control signals outputted by the digital control block (18) which has an N-bit input. Further, said variable gain amplifiers (14a, b) display “linear-in-dB” character in relation with the N-bit inputs controlling thereto; therefore making the overall SI suppression performance of the system independent of the output power of said power detector (16), enabling compliance with 10 dB level PAPR (Peak-to-average power ratio) requirement in the case of complex waveforms deemed to be utilized in the course of 5G technologies such as FBMC, (Filter Bank Multi-Carrier) UFMC (Universal Filtered Multi-Carrier) and GFDM (Generalized Frequency Division Multiplexing) notwithstanding.

FIG. 4 displays the circuit schematic of the gain stages together with an active vector combiner (15) that handles the demodulation of signals after modification thereof through variable gain amplifiers (14a, b), same signals which were separated into in-phase and quadrant constituents with the aid of I/Q modulator (13) off of the output of power amplifier (6) defined on the transmitting signal path (4). Instead of Wilkinson combiners which are quite common in applications of this kind, current summation method proves to be more advantageous in this regard: As demonstrated in the FIG. 2, part of the current delivered to the load is steered away from said load via current sources controlled by the logic circuit in the digital control block (18). With Kirchoff's current law in effect, outputs of in-phase and quadrant amplifiers share a common node and are combined accordingly. This arrangement of a position, velocity and time (PVT) technique utilizes mirroring, wherein a Fibonacci sequence is implemented, therefore increasing the degrees of freedom of the control logic, which in turn helps in further minimization of the self-interference signal.

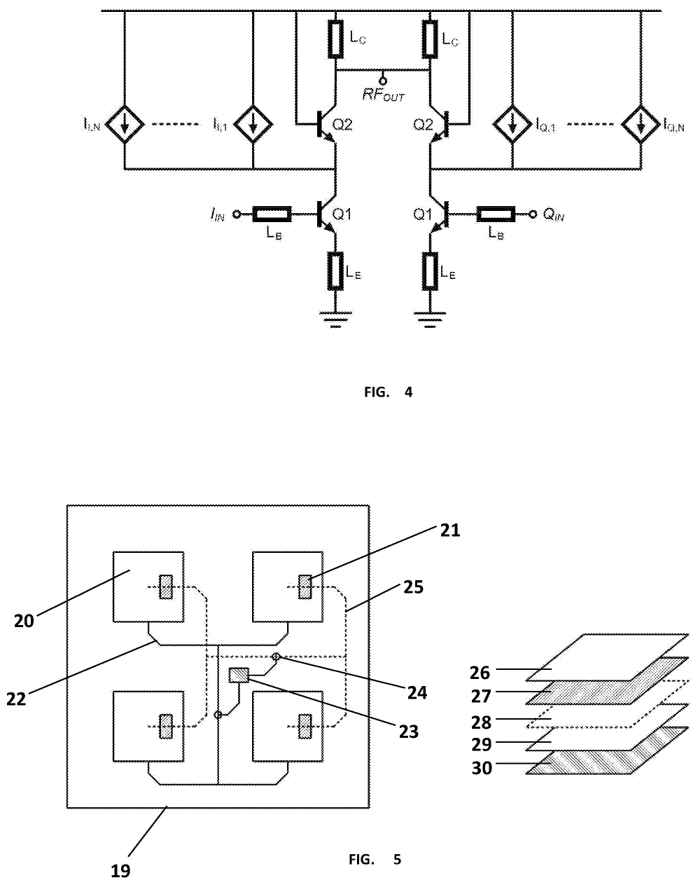

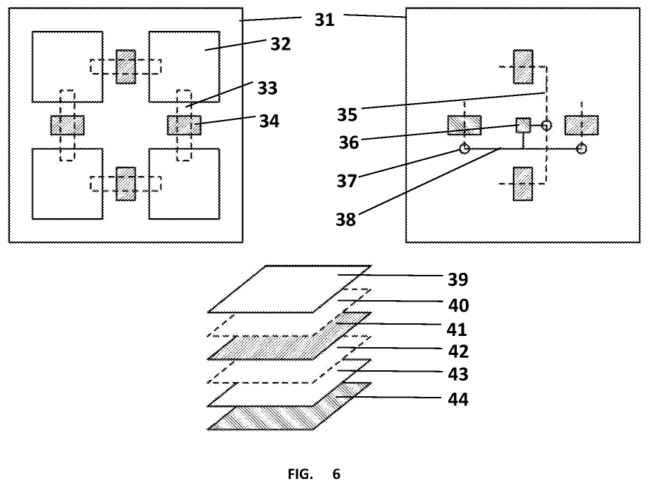

FIG. 5 demonstrates the top view of the patch antenna (2) more specifically dual-polarized Type-I antenna (19), in addition to the top perspective view of metallization layers of said passive suppression capable dual-polarized Type-I antenna (19) regarding the self-interference cancellation system (1) in the case of the disclosed invention. This antenna, while designed according to the specifications of a direct fed, aperture coupled architecture, comprises four stacked printed circuit board (PCB) elements, hence comprising five metallization layers overall. Topmost first layer (26) includes antenna patches (20) and direct coupled transmitter feed (22). Second layer (27) next to a ground (GND) incarnation, includes slots (21) for the aperture coupled receiver port. Strip line configuration of feed lines of receiver feed (25) are located on the third layer (28) to improve isolation. Fourth layer (29) acts still as a grounding means, whereas fifth layer (30) comprises a fill-duplex silicon-germanium chip (23) and supply connections (24) required for said Si—Ge chip (23). Desirability of this antenna array of Type-I arises from said antenna array consisting of only four dielectric layers, therefore comprising a compact structure.

FIG. 6 demonstrates an alternative to the previously mentioned Type-I antenna (19), namely Type-II antenna (31) which comprises an aperture coupled, stacked patch architecture composed of six metallization layers. Radiating antenna patches (32) are located on the top layer (39), while second layer (40) includes coupling strips (33) that are right above aperture slots (34) on the third layer (41). Between said first layer (39) and second layer (40) exists and air gap. Third layer (41) still serves as a ground, whereas a fourth layer (42) comprises transmission lines for receiving and transmitting elements to excite apertures thereof. When considered with the upper third layer (41) and the below fifth layer (43); fourth layer (42) lies sandwiched between two layers of ground (GND) nature, which maximizes the amount of physical isolation. Final sixth layer (44), in addition to the full-duplex Si—Ge chip (36) and its supply connections (37), further comprises a transmitter feed (38). The main advantage of this architecture is its complete bilateral symmetry in vertical and horizontal aspects considering the top three layers, which enables a very high level of isolation between receiver feed (35) and transmitter feed (38) elements. Contrarily, compared to its alternative architectural counterpart, is a more complex board in that it requires thicker metallization layers as well as an air gap.

To reiterate the working principle of the disclosed invention, a blind and adaptive self-interference cancellation system (1) designed to overcome the self-interference problem intrinsic to full-duplex systems, comprising an adaptive SI canceller (7) along with two types of patch antennas (19, 31) in array formation to mimic massive MIMO scalability properties. Based on the signal difference between Tx and Rx channels, blindness to environmental detriments as well as different ambient conditions, and a stable performance and wide-band operability is ensured with this feedback-utilizing system which stands as a strong system-level solution to 5G systems characterized with high data rates, massive MIMO radios and millimetre-wave transmission/reception.

In one aspect of the disclosed invention, a self-interference (SI) cancelling system (1) operating in a fill-duplex setting and produces a suppression/cancelling signal through a signal processing scheme controlled digital control block (18) to be combined to a signal on a channel is proposed.

In another aspect of the disclosed invention, said self-interference cancelling system (1) comprises an adaptive SI canceller (7) that produces a cancelling signal by sampling a receiving end split to phase constituents prior to being modified by at least one variable gain amplifier (14) controlled by a digital control block (18) induced by a power detector (16), after which they are combined to produce said cancelling signal.

In a further aspect of the present invention, said self-interference cancelling system (1) comprises at least one massive AMMO compatible patch antenna (2) to improve performance of said adaptive SI canceller (7).

In a further aspect of the present invention, said adaptive SI canceller is located between one receiving (3) and one transmitting (4) signal path.

In a further aspect of the present invention, said self-interference cancelling system (1) further comprises a low-noise amplifier (5) and a power amplifier (6) associated respectively with said receiving signal path (3) and transmitting signal path (4), which accommodate said adaptive SI canceller (7).

In a further aspect of the present invention, said adaptive SI canceller (7) further comprises at least one coupler (11) to couple signals at low-noise amplifier (5) and power amplifier (6) outputs.

In a further aspect of the present invention, said adaptive SI canceller (7) outputs preliminarily a feedback mechanism utilizing error an input signals delivered thereto.

In a further aspect of the present invention, said adaptive SI canceller (7) comprises and analog-to-digital converter receiving input as the output of said power detector (16), digitizing said input.

In a further aspect of the present invention, said adaptive SI canceller (7) comprises a digital control block (18) that assumes control according to input it receives from said analog-to-digital converter (17).

In a further aspect of the present invention, said adaptive SI canceller (7) further comprises an adjustment of in-phase and quadrant constituents of a signal rendered so by said I/Q modulator (13) using variable gain amplifiers (14).

In a further aspect of the present invention, said adaptive SI canceller (7) further comprises an analog-to-digital converter (17), said digital control block (18) will handle comparison of signals therefrom to control said variable gain amplifiers (14).

In a further aspect of the present invention, said adaptive SI canceller (7) further comprises at least one vector combiner (15) combining in-phase and quadrant constituents changed via variable gain amplifier(s) (14).

In a further aspect of the present invention, said system (1) further comprises an impedance matching transformer for passive suppression.

In a further aspect of the present invention, said system (1) further comprises a Type-I antenna (19) comprising 2×2 patches (20).

In a further aspect of the present invention, said Type-I antenna (19) further comprises five metallization layers.

In a further aspect of the present invention, said Type-I antenna (19) comprises direct-fed, aperture coupled architecture.

In a further aspect of the present invention, said system (1) further comprises a Type-II antenna (31) comprising 2×2 patches (32).

In a further aspect of the present invention, said Type-II antenna (31) further comprises six metallization layers.

In a further aspect of the present invention, said Type-I antenna 19 comprises direct-fed, aperture coupled architecture.

What is claimed is:

1. A self-interference (Si) cancelling system operating in a full-duplex setting and producing a suppression/cancelling signal through a signal processing scheme controlled by a digital control block to be combined to a signal on a channel characterized in that;
said self-interference cancelling system comprises an adaptive Si canceller that produces the cancelling signal by sampling a receiving end split to phase constituents prior to being modified by at least one variable gain amplifier controlled by the digital control block induced by a power detector, and modified in-phase and quadrature components are combined to produce said cancelling signal, and;
said self-interference cancelling system comprises at least one massive MIMO compatible patch antenna to improve performance of said adaptive Si canceller.

2. The self-interference (Si) cancelling system as set forth in claim 1, characterized in that said adaptive Si canceller is located between one receiving and one transmitting signal path.

3. The self-interference (Si) cancelling system as set forth in claim 1, characterized in that said self-interference cancelling system further comprises a low-noise amplifier and a power amplifier associated respectively with said receiving signal path and the transmitting signal path, which accommodate said adaptive Si canceller.

4. The self-interference (Si) cancelling system as set forth in claim 1, characterized in that said adaptive Si canceller further comprises at least one coupler to couple signals at a low-noise amplifier and a power amplifier outputs.

5. The self-interference (Si) cancelling system as set forth in claim 4, characterized in that said adaptive Si canceller outputs preliminarily a feedback mechanism utilizing error an input signals delivered thereto.

6. The self-interference (Si) cancelling system as set forth in claim 4, characterized in that said adaptive Si canceller comprises and an analog-to-digital converter receiving input as the output of said power detector, to digitize said input.

7. The self-interference (Si) cancelling system as set forth in claim 5, characterized in that said adaptive Si canceller comprises the digital control block that assumes control according to input it receives received from an analog-to-digital converter.

8. The self-interference (Si) cancelling system as set forth in claim 4, characterized in that said adaptive Si canceller further comprises an adjustment of in-phase and quadrant constituents of a signal rendered so by said I/Q modulator using the at least one variable gain amplifier.

9. The self-interference (Si) cancelling system as set forth in claim 8, characterized in that said adaptive Si canceller further comprises an analog-to-digital converter, said digital control block handles comparison of signals therefrom to control the at least one variable gain amplifier.

10. The self-interference (Si) cancelling system as set forth in claim 1, characterized in that said adaptive Si canceller further comprises at least one vector combiner combining in-phase and quadrant constituents changed via the at least one variable gain amplifier.

11. The self-interference (Si) cancelling system as set forth in claim 1, characterized in that, said system further comprises an impedance matching transformer far passive suppression.

12. The self-interference (Si) cancelling system as set forth in claim 1, characterized in that, said system further comprises a Type-I antenna comprising 2×2 patches.

13. The self-interference (Si) cancelling system as set forth in claim 12, characterized in that, said, Type-I antenna further comprises five metallization layers.

14. The self-interference (Si) cancelling system as set forth in claim 12, characterized in that, said Type-I antenna comprises a direct-fed, aperture coupled architecture.

15. The self-interference (Si) cancelling system as set forth in claim 1, characterized in that, said system further comprises a Type-II antenna comprising 2×2 patches.

16. The self-interference (Si) cancelling system as set forth in claim 15, characterized in that, said Type-II antenna further comprises six metallization layers.

17. The self-interference (Si) cancelling system as set forth in claim 15, characterized in that, said Type-I antenna comprises a direct-fed, aperture coupled architecture.
